(19) United States
(12) Patent Application Publication
(10) Pub. No.: US 2006/0203084 A1
(43) Pub. Date: Sep. 14, 2006

(54) Fixture and an image forming device

(75) Inventors: Yutaka Okazaki, Niigata (JP); Takeshi Yawata, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/371,246

(22) Filed: Mar. 8, 2006

(30) Foreign Application Priority Data
Mar. 9, 2005 (JP) 2005-065597

(51) Int. Cl. H04N 13/02

(52) U.S. Cl. 348/46; 348/43

(57) ABSTRACT

A fixture which can easily fix a small display device in desired position to a pair of glasses is provided. The fixture which fixes the small display device to the glasses includes; a clip which grips a part of the glasses; a bar which extends from the clip; a slider which is supported by the bar and slides on and along the longitudinal direction of the bar; a joint which is coupled to the slider and rotates around the rotation axis which is perpendicular to the longitudinal direction of the bar; and a display device holder which is coupled to the joint, rotates around the rotation axis which is perpendicular to the rotation axis of the joint, and holds the small display device.

### CROSS REFERENCE TO RELATED APPLICATION

The present application claims priority from a Japanese Patent Application No. JP 2005-065597 filed on Mar. 9, 2005, the contents of which are incorporated herein by reference.

### BACKGROUND OF THE INVENTION

1. Field of the Invention

The present invention relates to a fixture and an image forming device. Especially, the present invention relates to a fixture used for fixing a small display device to a pair of glasses, and an image forming device using the small display device.

2. Related Art

Conventionally, there are fixtures used for fixing a magnifying glass to a pair of glasses as disclosed, for example, in Japanese Patent Application Publication No. 2003-295128. The fixture comprises a clip which grips a part of the glasses, a bar which attaches a magnifying glass, and a bridge which joins the clip and the bar. There is another prior art that a small liquid crystal display device which is set near the either or both eyes of a viewer.

Fixed with the above fixture to the glasses, the small liquid crystal display device is adjusted the height by moving the bridge up and down, or adjusted the horizontal position by loosening the screw, with which the display device is fixed to the bar to slide on the bar. The display device has to be adjusted vertically and horizontally with respective separate adjusters. If the display devices set near both the left and right eyes, the display devices cannot be adjusted independently.

### SUMMARY OF THE INVENTION

To solve the above problems, the first embodiment of the present invention is a fixture with which a small display device is fixed to a pair of glasses, which includes; a clip which grips a part of the glasses; a bar which extends from the clip; a slider which is supported by the bar and slides on and along the longitudinal direction of the bar; a joint which is coupled to the slider and rotates against the slider around the rotation axis which is perpendicular to the longitudinal direction of the bar; and a display device holder which is coupled to the joint, rotates around the rotation axis which is perpendicular to the rotation axis of the joint, and holds the small display device.

In the above fixture, the slider and the joint may have a pair of flat surfaces respectively, each of which is parallel to their respective rotation axis thereof.

In the above fixture, the display device holder looks like the character of C, and the notch of the C-shaped holder fits up the hook of the small display device.

In the above fixture, the bar may extend horizontally beyond the clip.

According to the second embodiment of the present invention, an image forming device includes; an image information generating unit in which an image is formed; a small display device in which the image formed by the image information generating unit is displayed thereon; a fixture which fixes the small display device to a pair of glasses; an attachment which attaches to the lens of the glasses to fasten the small display device. The fixture includes; a clip which grips a part of the glasses; a bar which extends from the clip; a slider which is supported by the bar and slides along the longitudinal direction of the bar, a joint which is coupled to the slider and rotates around the rotation axis which is perpendicular to the longitudinal direction of the bar; and a holder which is coupled to the joint, rotates around rotation axis which is perpendicular to the rotation axis of the joint, and holds the small display device.

The above description of the present invention doesn't cite all the features of the present invention. The sub-combinations of these features may also be inventions.

Apparently from the above description, according to the present invention, a small display device can be easily fixed to a pair of glasses in the desired position.

### BRIEF DESCRIPTION OF THE DRAWINGS

FIG. 1 is a perspective view showing the image forming device 20 related to the embodiment of the present invention is fixed to the glasses 10.

FIG. 2 is a perspective view of the fixture 100.

FIG. 3 is an exploded perspective view of the fixture 100.

FIG. 4 is a front view of the fixture 100.

FIG. 5 is a bottom view of the fixture 100.

FIG. 6 is a side view of the fixture 100 seen from the side of the display device holder 170.

FIG. 7 is a rear perspective view showing the display device holder 170 fitting to the small display device 40.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

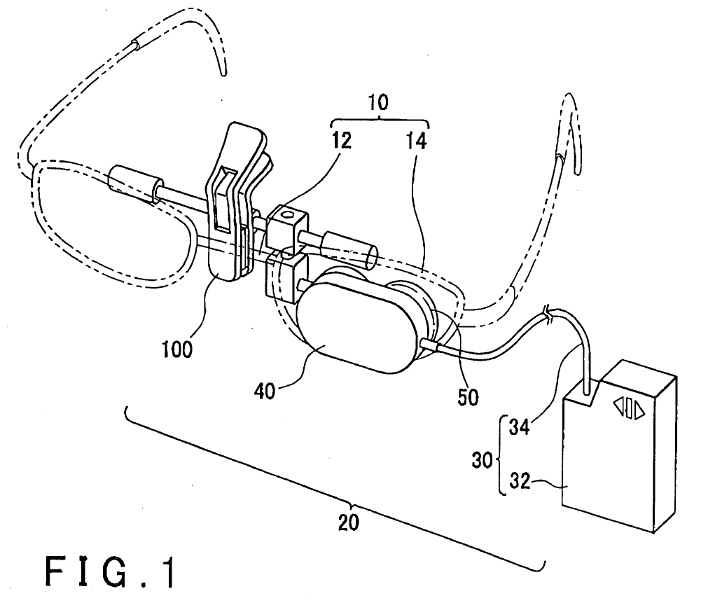

FIG. 1 is a perspective view showing the image forming device 20 related to the embodiment of the present invention is fixed to a pair of glasses 10. The image forming device 20 forms an image to display it to a user of the pair of glasses 10. The image forming device 20 includes; a image information generating unit 30 which forms an image; a small display device 40 which displays the image formed by the image information generating unit 30; a fixture 100 which fixes the small display device 40 to the pair of glasses 10; and an attachment 50 which attaches to the lens 14 of the glasses 10 to fasten the small display device 40. The lens 14 is not required to perform a function as an optical lens. For example, the lens 14 may be a glass plate.

The image information generating unit 30 includes a main body 32 and a cable 34 which connects the main body 32 and the small display device 40. The main body of the image information generating unit 32 reads out an image stored in storage media to form the image, and sends the image via the cable 34 to the small display device 40. The image information generating unit 30 may send the image to the small display device 40 wirelessly without the cable 34. The small display device 40 includes, for example, a one inch liquid crystal panel and one or more lenses to display the image sent from the main body of the image forming device 32.

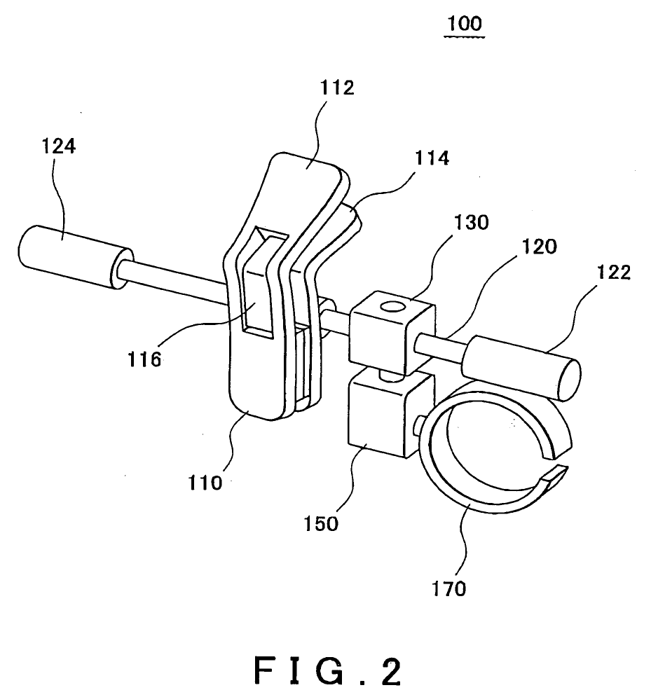

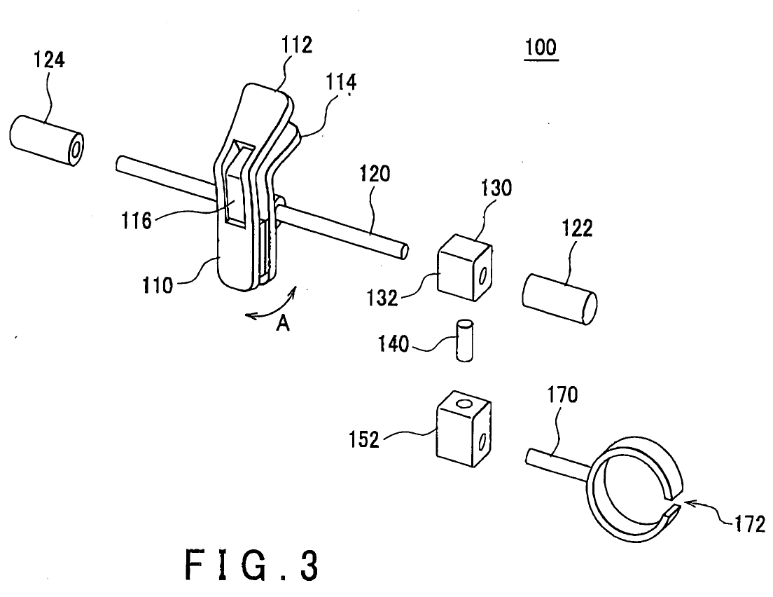

FIG. 2 is a perspective view of the fixture 100. FIG. 3 is an exploded perspective view of the fixture 100. As shown in the FIGS. 2 and 3, the fixture 100 includes a clip 110 which grips a frame 12 of the glasses 10, a bar 120 which extends from the clip 110, a slider 130 which is supported by the bar 120, a joint 150 which is coupled to the slider 130, and a display device holder 170 which is coupled to the joint 150.

The clip 110 comprises a pair of holding members 112 and 114, and a leaf spring 116 which joins the pair of holding member 112, and 114. The pair of holding members 112 and 114 open and shut in the direction indicated by the arrow A in FIG. 3. In the above structure, one ends (the upper sides in the figure) of the pair of holding members 112 and 114 are pinched to get them close together, while the other ends (the lower sides in the figure) thereof are opened. The user puts the frame 12 of the glasses 10 between the other open ends of the pair of holding members 112 and 114, and releases the one ends thereof to fix the pair of holding members 112 and 114 on the frame 12.

The bar 120 is made of resin, goes through the holding member 114 of the clip 110, and extends beyond the clip 110. The bar 120 is supported by the holding member 114 of the clip 110. Both the ends of the bar 120 are provided with stoppers 122 and 124 respectively.

The slider 130 is made of resin and molded in rectangular solid. The slider 130 has a through-hole whose openings are on the pair of facing surfaces (the left and right surfaces in the figure) of the rectangular solid body. The bar 120 is inserted to the through-hole to support the slider 130. The slider 130 also has a hole whose opening is on the surface thereof (the bottom surfafce, not shown in the figure) which is perpendicular to the surfaces having the openings of the through-hole. A coupling rod 140 is inserted into the hole.

The joint 150 is made of resin and molded in rectangular solid. The joint 150 has a surface (the upper surface in the figure) having a hole. The coupling rod 140 is inserted into the joint 150 to connect the joint 150 to the slider 130. The joint 150 further has another hole whose opening is perpendicular to the surface (right side in the figure) having the opening of the above described hole.

The display device holder 170 is made of resin and molded in C-shape. A part of the display device holder 170 is inserted into the the other hole of the one surface of the joint 150 to be connected the joint 150.

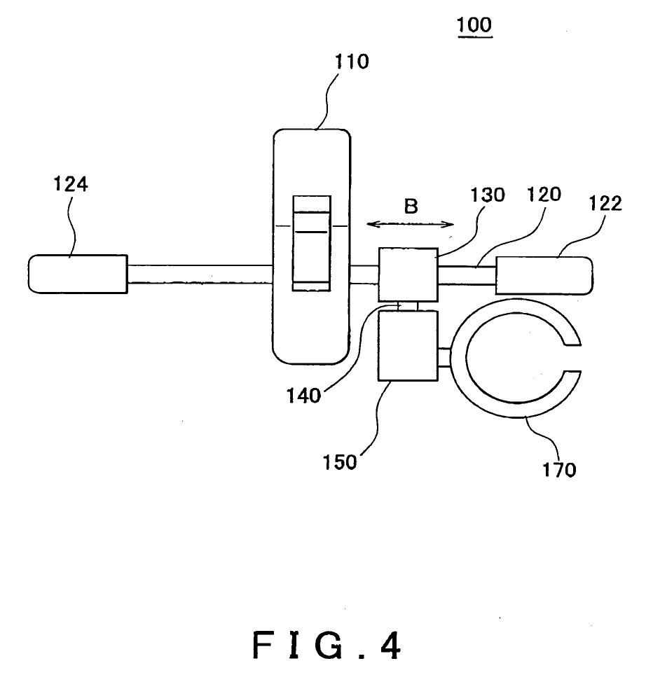

FIG. 4 is a front view of the fixture 10 seen from the front. As shown in FIG. 4, the slider 130 slides on the bar along the longitudinal direction of the bar 120, or the direction indicated by the arrow B. The small display device 40 can adjust the lateral or horizontal position relative to the glasses.

The slider 130 or other components can be assembled on the bar 120, which extends beyond the clip 110 on both sides. The small display device 40, therefore, can be assembled on either lens 14 of the glasses 10.

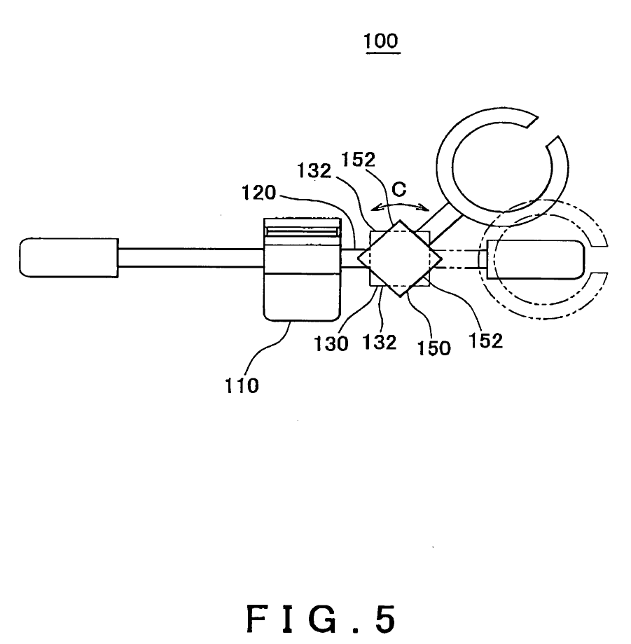

FIG. 5 is a bottom view of the fixture 100 seen from the bottom. As shown in FIG. 5, the joint 150, serving as an intermediate member, rotates around the coupling rod 140 against the slider 130. The joint 150, therefore, rotates around the rotation axis which is perpendicular to the longitudinal direction of the bar 120, or in the direction indicated the arrow C. This allows the small display device 40 to adjust the distance from the lens 14 and the direction in the horizontal plane. The slider 130 and the joint 150 have surfaces 132 or 152 respectively which are parallel to the coupling rod 140. Pinching the slider 130 and the joint 150 with the flat surfaces 132 or 152, the user can easily rotate the joint 150 against the slider 130.

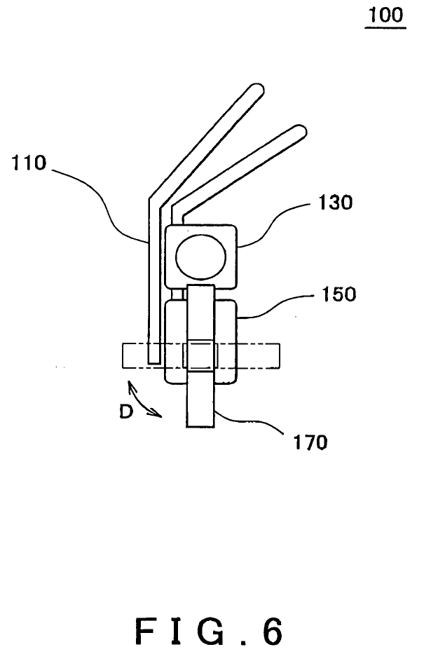

FIG. 6 is a side view of the fixture 100 seen from the side of the display device holder 170. As shown in FIG. 6, the display device holder 170 rotates around the rotation axis which is perpendicular to the rotation axis of the joint 150, or in the direction indicated by the arrow D. This allows the small display device 40 to adjust the direction to the lens 14 in the vertical plane. The joint 150 is coupled to the display device holder 170 so that the small display device 40 can be adjusted freely in the six directions in three dimensional space with this junction.

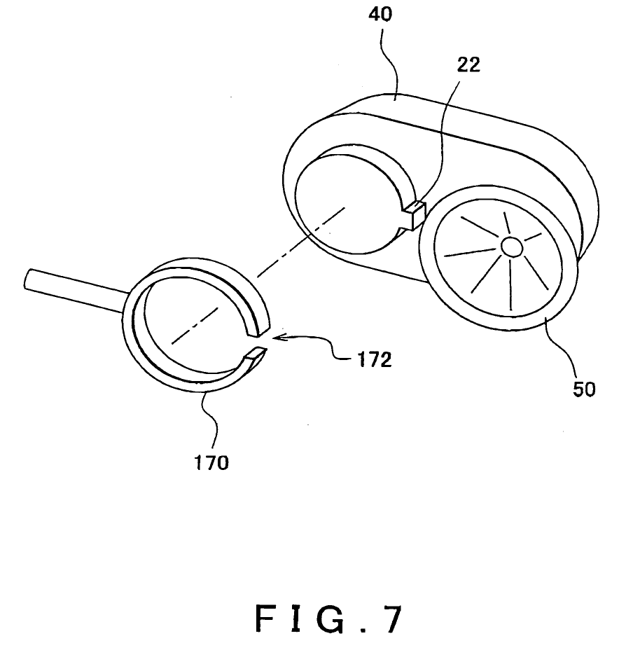

FIG. 7 is a rear perspective view of the display device holder 170 holding the small display device 40. The small display device 40 has a hook 22. The hook 22 of the small display device 40 is fitted to the C-shaped display device holder 170 with the notch 172. Owing to this structure, the small display device 40 is positioned with respect to the notch 172. Specifically, the small display device 40 can be positioned accurately in a rotating direction on a plane defined by the C-shaped display device holder 170. Because the notch 172 expands the display device holder 170, the small display device 40 may readily be attached to and detached from the display device holder 170. The attachment 50 is, for example, a suction pad, which sticks at the lens 14 of the glasses 10 to fasten the small display device 40 to the glasses 10.

According to the present invention, when fixed to the glasses 10, the small display device 40 can be freely adjusted the position in the six directions in three dimensional space with adjusters which are close to each other. The small display device 40 can, therefore, be fixed to the glasses 10 at the desired position. Further, when fixed to the left/right lens 14 of the glasses 10, the position and direction of the small display device 40 can also be adjusted independetntly.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is

1. A fixture with which a small display device is fixed to a pair of glasses, which includes;
a clip which grips a part of the glasses;
a bar which extends from said clip;
a slider which is supported by said bar and slides on and along the longitudinal direction of said bar;
a joint which is coupled to said slider and rotates against said slider around the rotation axis which is perpendicular to the longitudinal direction of said bar; and
a display device holder which is coupled to said joint, rotates around the rotation axis which is perpendicular to said rotation axis of said joint, and holds said small display device.

2. The fixture according to claim 1, wherein said slider and said joint respectively have a pair of flat surfaces, each of which is parallel to said respective rotation axis thereof.

3. The fixture according to claim 1, wherein said display device holder looks like the character of C, and the notch of the C-shaped holder fits up the hook of said small display device.

4. The fixture according to claim 1, wherein said bar extends horizontally beyond said clip.

5. An image forming device which includes;
an image information generating unit in which an image is formed;
a small display device in which the image formed by said image information generating unit is displayed thereon;
a fixture which fixes said small display device to a pair of glasses; and
an attachment which attaches to the lens of said glasses to fasten the small display device, and
wherein said fixture includes;
a clip which grips a part of the glasses;
a bar which extends from said clip;
a slider which is supported by said bar and slides on and along the longitudinal direction of said bar;
a joint which is coupled to said slider and rotates against said slider around the rotation axis which is perpendicular to the longitudinal direction of said bar; and
a holder which is coupled to said joint, and rotates around the rotation axis which is perpendicular to said rotation axis of said joint, and holds said small display device.
